(19) United States
(12) Patent Application Publication
(10) Pub. No.: US 2004/0249747 A1
(43) Pub. Date: Dec. 9, 2004

(54) Signature verification apparatus and method

(76) Inventor: Artoun Ramian, Marbella (ES)

Correspondence Address: Law Office of William B. Ritchie, 43 Jackson Street, Concord, NH, 03301, US

(21) Appl. No.: 10/764,987

(22) Filed: Jan. 26, 2004

Related U.S. Application Data
(60) Provisional application No. 60/442,967, filed on Jan. 27, 2003.

(51) Int. Cl. G06F 17/60; H04K 1/00; H04L 9/00

(52) U.S. Cl. 705/39; 705/75; 705/67

(57) ABSTRACT

The invention is a fraud prevention system and method to protect a credit card user from financial misappropriation and identify theft. Means for comparing a transaction receipt signature against another signature is provided. If the comparison does not meet certain predetermined criteria, the need for additional identification is automatically conveyed to the sales associate. The user is provided means for transaction details forwarded to the user's mobile phone or email address. Further, once the transaction has been completed, any remaining paper traces of the transaction at the point of sale are destroyed. Means for allowing the issuing company to electronically send a message which will result in the destruction of the card in use is also provided. The user can be provided with an electronic journal which will serve as a repository of all transactions so that any unauthorized use of the user's credit card will be found more quickly. The employment of an electronic comparison of the user's signature as it appears on the credit card eliminates human error.

### BACKGROUND OF INVENTION

1. Field of the Invention

The present invention generally relates to an identity verification system for credit card purchases. This application claims benefit of U.S. Provisional Application Ser. No. 60/442,967, filed Jan. 27, 2003, pursuant to 35 USC §119(e).

2. Description of the Related Art

The global economy is fueled by the countless transactions, executed on a daily basis by consumers. By far, one of the most popular methods of paying for goods and services is by credit card. Other options, such as bank debit cards, store cards and the like exist, all of which are fundamentally similar to purchasing by credit card such that a card has been signed by the user and the user's signature on the sales slip is compared against one another.

Billions of US Dollars are lost each year to credit card fraud, perpetrated by criminals, usually utilizing various methods of theft of identity. Credit card companies find themselves continually increasing budgets for such losses as the number of credit card transactions increases.

In order to reduce the billions of dollars lost, the retailer typically ends up investing further millions of dollars in security systems and fraud detection.

As noted above, a purchase with a credit card is performed by the user by selecting the goods, presenting the credit card as payment, signing a transaction slip and leaving the store. The store assistant is burdened with the task of visually comparing the original signature, held on the reverse side of the card, with a current signature which is placed by the consumer on a transaction slip.

In Europe, with the advent of the Euro currency bank notes, it is not uncommon to see a forged bank note detector, a specialized form of document scanner, at every point of sale, throughout entire department store.

The disparity between the level of security checks used for cash, and those paid for by credit card or other card types is quite apparent. While it is deemed sufficient for a sale associate to perform a visual check of two signatures, it is not sufficient for the same sales associate to visually inspect bank notes. Of course, the losses from accepting counterfeit money are absorbed by the store while the losses for fraudulent use of a credit card are shifted to the credit card issuer and ultimately the credit card user via high interest charges.

A further problem exists, and this can often be seen evidenced in credit card transactions which are executed in the absence of the holder. A card holder, who is too busy to visit a store, sends a representative with their credit card, to make purchases on their behalf. The stores tolerate this behavior, especially amongst high spending customers, as being a necessity for those who are too busy, or who have staff to execute their purchases for them. So the sale associate at the store is unlikely to check the signature believing the person using the credit card has been duly authorized by the card holder to make purchases.

In consumer affairs surveys, the failure of a sales associate to check signatures is quite common. These points out the risk in delegating this task to the store sales personnel.

Several reasons exist for improper signature verification. This can be deliberate, in that the sales associate just can not be bothered to perform the check. It can be unintentional, in that they just forget. It can also be due to a poor level of eyesight or lack of knowledge in what to look for when comparing signatures.

Consequently, it is not uncommon for users to sign the transaction receipt with a strange squiggle, or to use the name of a famous cartoon character. Under such circumstances, it is obvious that no signature verification had been undertaken or was not performed to a satisfactory level. Therefore, at least, manual verification involving human assessment of signatures is unreliable to prevent fraud.

The consumer should be able to have trust in the merchant that upon entering into a transaction, the information they provide be used solely for the purposes of the present transaction. However, when the consumer executes the transaction and signs the receipt slip, a paper trail is formed. The paper trail is a major contribution to theft of identity and if creation of same is avoided, there would be little physical matter available to a criminal pursuing such information in order to misappropriate funds. With electronic archiving at its cutting edge, at the current time, it gives rise to questions of why receipt slips are not simply digitized, stored electronically and destroyed.

When a user withdraws funds from an Automatic Teller Machine (ATM), they have an option to take a receipt or not. The reason for this option is the receipt is frequently discarded without thought, and again, this valuable piece of paper often contains essential information for use in theft of identity. It has been reported many times, that a receipt, plus a video recorded session of the user entering their PIN code, is sufficient to create a fully functioning copy of an ATM card, without ever having to have sight of the card which is being copied.

So a receipt, or transaction slip of any kind, discarded without thought, can trigger a financial catastrophe for the person affected by fraud.

Having a point of sale unit send a message to a mobile phone, detailing the transaction which has just been processed is not found in the current art. In order to track spending, users are burdened with numerous receipts and expected to manually enter those details into personal ledgers and accounting systems. It is doubtless that thousands of transposition errors occur, where incorrect details are entered.

So the current art is heavily dependent upon providing a paper trail and would find it virtually impossible to function without it. Proof of purchase is essential in proving fraud, so there seems little scope for reduction of the paper trail using current methods and equipment.

Therefore, a fraud prevention system and method that meets the security needs of the majority of purchase transactions while having accurate signature verification, card reading and destruction of the paper trail is not found in the prior art.

### SUMMARY OF THE PRESENT INVENTION

It is an aspect of the present invention to provide a means for validating a customer's signature on a transaction when used with most types of payment cards.

A means for comparing a transaction receipt signature against another signature is provided. If the comparison does not meet certain predetermined criteria, the need for additional identification is automatically conveyed to the sales associate. A user is provided means for transaction details forwarded to his/her mobile phone, email address and to destroy any remaining paper traces of the transaction. Finally, means for allowing the issuing company to electronically send a message which will result in the destruction of the card in use is also provided.

The present invention is a fraud prevention system, which are combined to protect the consumer from financial misappropriation and theft of identity. The transaction process will appear to be very familiar to any user as outwardly the invention requires the user to provide a signature on a traditional transaction slip, something which is an every day occurrence. The primary differences between the present invention and the prior art is that the card, transaction slip and other optional details are entered automatically and eliminates the high degree of uncertainty of having a sales associate make the signature verification.

A signature panel which presents a space in which the user can provide their signature or other identifying mark is provided. Optionally, the user can also write a mobile telephone number. The mobile telephone, nominated for the transaction, will override any previous mobile telephone number such that transaction details can be sent to remote location for the purposes of having an electronic copy of the transaction.

At the time of registering for a credit or other form of payment card, the user can provide contact details concerning a mobile telephone or email address, where appropriate. The contact details can then be indicated as static i.e. can not be overridden at the point of sale, or dynamic, in which case the user is able to execute the transaction specifying alternative contact details. This is a highly convenient feature for a user. A user can be provided with an electronic journal which forms automatically in the user's mobile phone, or email in-box, detailing transaction details. Transaction details for the email form of communication can be much more thorough than those provided in the mobile phone method. In the second instance, if a user r ceives transaction details that they are not aware of, i.e. an unauthorized transaction is in progress, or has been completed, it will come to their attention much sooner than by prior art methods.

The present invention features a first scanner, for the purposes of digitizing the credit card signature panel, a second scanner for digitizing the transaction slip, a magnetic card stripe reader, a shredder for the purposes of destroying the transaction slip and optionally provides a modem for the purposes of electronic communication with the user or other parties.

Other aspects, features and advantages of the present invention will become obvious from the following detailed description that is given for the embodiments of the present invention while referring to the accompanying drawings.

### BRIEF DESCRIPTION OF THE DRAWINGS

FIG. 1 is a block diagram of the present invention.

### DETAILED DESCRIPTION OF THE INVENTION

The present invention is information processing apparatus and method which compares and validates two signatures as being substantially identical.

A customer enters into a transaction with a merchant. Standard Transaction Process (STP) is defined to have the following steps. The customer selects goods or services available from the merchant, and opts to utilize a form of payment card, for example a credit card. The customer presents their credit card, which is read by the merchant's electronic funds transfer by point of sale (EFTPOS) equipment. The merchant then requests that the customer sign a slip containing the details of the transaction. A first signature, held on the credit card, is digitized by a first scanner. The transaction slip is digitized by a second scanner, and contains a second signature. A comparison of the first signature and the second signature is made. The comparison yields a true condition if the first signature and the second signature are substantially identical. If the comparison yields a true condition then the transaction is deemed to be authenticated, otherwise it is deemed to have failed.

Extended Transaction Process (ETP) is defined to include all steps of STP, and additionally provides the following steps. When the customer applied for the credit card, they are asked to provide an optional mobile telephone number and email address, defined as Primary Contact Details (PCD). When the transaction slip is digitized by the second scanner, the additional information of a mobile telephone number and email address is sought, defined as Secondary Contact Details (SCD).

When the customer applies for the credit card, they can state whether SCD can override PCD, if so, the mobile telephone number of the SCD will be used in preference to the mobile telephone number of the PCD. Similarly, if SCD may override PCD then the email address comprised by SCD will override the email address of the PCD. Thus, the present invention formulates a mobile telephone number and or email address, defined as Transaction Contact Details (TCD). If PCD and SCD are unavailable the present invention is unable to form TCD, and therefore ETP is unavailable. If ETP is available, then the customer, by using contact details of the TCD, will be informed of the transaction details.

Therefore ETP is used for informing the customer that a transaction has been completed, and the customer is able to electronically transfer contact details to an accounting system, if so desired.

ETP acts to track transactions and alert the customer to any unauthorized transactions. Additionally, where a corporate entity may have numerous credit card holders, and requires tracking of expenditures occurring, for example, through credit card use. The corporate entity will therefore be able to utilize ETP to track transactions logged in accounting journals, substantially in the same moment that they are completed.

A primary card holder may authorize supplementary card holders. Supplementary card holders are defined as users who have a card issued to them which is billed to and paid for by the primary card holder. Similarly, using ETP, the primary card holder is able to track expenditures by supplementary card holders in the same manner as a corporate entity.

Destructive Transaction Processing (DTP) is defined as including the steps of either STP, or ETP, but having an additional step of destroying the transaction receipt.

As a first example of DTP, STP may be executed to completion, with a S successful or failed transaction, which is then followed by shredding the transaction paperwork.

As a second example of DTP, ETP may be executed to completion, with a successful or failed transaction, which is then followed by again shredding the transaction paper records.

Therefore, any form of transaction can be formulated by having a number of steps. Further, it can be seen that any transaction, formulated as described, can finally end with the destruction of the transaction receipt and all embodiments of a transaction ending in shredding of the transaction paperwork are included within the DTP step.

Any embodiment of the invention can include DTP to make certain that no paper trail of the transaction receipt remains. Therefore, the user DTP further assists in preventing fraud, i.e. copying and forging of a signature or account details, misappropriation from any remaining transaction receipt, is avoided.

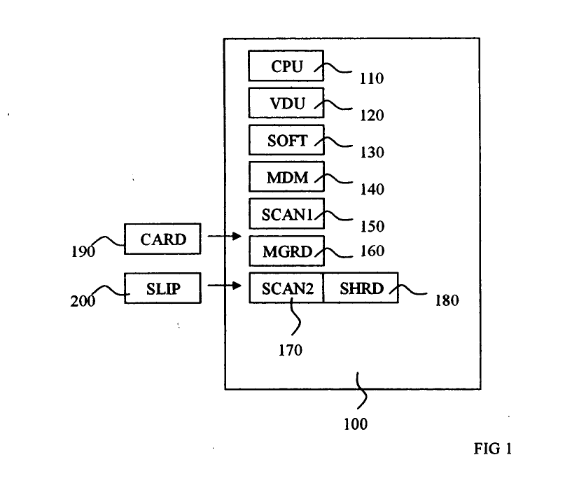

Referring to FIG. 1, the invention is transaction processing equipment (TPE) 100 which includes central processing unit (CPU) 110 that is well known in the art. Also, visual display unit (VDU) 120 is also well known in art and any device suitable for displaying information is acceptable. Software (SOFT) 130 is likewise well known in the art as current readily available programs for comparing at least two signatures are available. Modem (MDM) 140 is included so that TPE can communicate electronically over the telephone lines. Document scanner SCAN1 150 is also provided. MGRD 160 optionally reads magnetic strips found on payment cards typified by credit cards and the like. A second document scanner is also provided. The invention is completed by an optional paper shredder, identified as SHRD 180.

In preferred embodiment, a user will be able to have credit card transactions processed using invention 100. In an alternative embodiment, MGRD 160 can be omitted from TPE 100, in which case the credit card transaction will be processed by means of Electronic Funds Transfer at Point of Sale (EFTPOS), equipment owned by the merchant of good or services. If EFTPOS equipment is preferred by the merchant, all of which is known in the art, is then TPE 100 will simply act as a means of comparing at least two signatures having a means of providing DTP.

Another embodiment of TPE 100 can be formed by omitting MGRD 160 and MDM 140, in which case TPE 100 acts solely as a means of comparing two signatures but still offering DTP facilities. Still another embodiment of TPE 100 can be formed by omitting MGRD 160 and MDM 140 and SHRD 180, in which case TPE 100 acts solely as a means of comparing two signatures, but can not offer STP, ETP or DTP facilities.

The basic embodiment of the invention is defined as Basic Processing Equipment (BPE) which is formed by having TPE 100 include only CPU 110, VDU 120, SOFT 130, SCAN1 150 and SCAN2 170.

BPE will therefore act only to automatically compare a first signature acquired from CARD 190 and a second signature acquired from SLIP 200, representing the transaction slip.

CPU 110, VDU 120 and optionally MDM 140 can be enabled by utilizing a laptop or other form of personal computer. SOFT 130 will therefore be able to execute on the laptop or other form of personal computer.

SOFT 130 which will compare at least two signatures is readily available, but SOFT 130 must include additional further logic, as will be recognized and can be easily accomplished by those having ordinary skill in the art if the preferred embodiment it to include all components illustrated in TPE 100 on FIG. 1.

SOFT 130 will require logic to detect and read CARD 190, first utilizing SCAN1 150 to digitize the first signature, then utilizing MGRD 160 to acquire data on magnetic strip of a credit card.

SOFT 130 will require logic to detect and digitize the transaction receipt, identified as SLIP 200, in order to acquire at least the second signature, and then seek the SCD.

SOFT 130 will require logic for utilizing the TCD and MDM 140, in order to inform the user of the transaction details as specified in ETP.

SOFT 130 will require logic and two alternative paper paths, if SHRD 180 is included in any embodiment.

SOFT 130 will utilize a first paper path which bypasses SHRD 180, if no form of DTP is required.

SOFT 130 will utilize a second paper path, feeding SLIP 200 through SHRD 180 to achieve substantially total destruction of SLIP 200 to satisfy the requirements of DTP.

It is recognized that not all the hardware present on a standard laptop or other personal computer is required in order to construct the present invention. Rather the laptop or other personal computer is used as the most convenient way of teaching one of ordinary skill to construct the invention.

Furthermore, in order to keep the descriptions of the various embodiments of the present invention as succinct as possible, numerous descriptions of circuits such as power supplies, paper insertion detectors, friction paper feeds and the like have been omitted, as one of ordinary skill in this art will recognize these as prerequisites for energy requirements and paper and credit card movement, throughout the various embodiments of the invention.

Therefore, in the illustrated embodiment of BPE, a user will have a simple way to verify the identity of the customer, by comparing at least two signatures, as is recognized in the current art as a valid procedure to verify the identify of claimed authorized user.

Furthermore in the more complex embodiments of the invention, a user will have all means offered by BPE, with the additional benefits of fraud detection offered through ETP, and fraud prevention offered by means of DTP.

In order to complete a basic purchase transaction (BPT) the merchant is required to process a credit card payment by first by utilizing BPE, which will verify signatures offered by the user during the transaction process, followed by utilization of EFTPOS equipment to recover payment from the customer.

A further embodiment of the present invention, defined as Secure Process Equipment, is possible by the omission of SCAN1 150, wherein a signature is also omitted from CARD 190.

SPE compares the second signature gained from SLIP 200, with a signature held by the credit card issuing company, defined as a remote signature.

In the first case, the remote signature is downloaded from the credit card issuing company and is compared with the second signature. This relieves the invention of having to digitize a signature on CARD 190. Furthermore, the signature panel of CARD 190 can be omitted. Therefore, a more secure credit card is formulated as no forger is able to gain access to the signature of the card holder, by misappropriating the credit card.

In the second case, as with the first case, the signature comparison is executed, but this time it is executed by the credit card issuing company, by any embodiment including MDM 140, transmitting the second signature to the credit card issuing company, which then compares the second signature and the remote signature and returns success or failure to the embodiment in use.

The purpose of all embodiments is, at the minimum, to automate the comparison of two signatures, such that the burden of manual comparison is lifted from the sales associate or other representative of the merchant.

Signature recognition software suitable for military use is readily available; therefore, constructing of a commercial system having a high degree of confidence to detect fraud is well within the capability of those having ordinary skill in this software field.

The illustrated embodiments of the invention are intended to be illustrative only, recognizing that persons having ordinary skill in the art may construct different forms of the invention that fully fall within the scope of the subject matter disclosed herein.

What is claimed is:

1. A method for validating a user's signature on a transaction at a point of sale with said user using a typical payment card, said method comprising the steps of:
signing the signature block of the payment card by the user;
recording the written signature of said user at the point of sale;
comparing the written signature of said user at the point of sale to the written signature of said user on the signature block of the payment card that was signed by said user at an earlier point in time;
notifying a sales associate at the point of sale whether the compared signatures of said user meets a predetermined criteria such the transaction is permitted to be completed wherein said transaction is duly recorded.

2. The method of claim 1 further comprising the step of:
communicating the transaction to a distant location via a predetermined contact telecommunication method specified by the user.

3. The method of claim 2 further comprising the step of:
destroying any paper traces of the transaction once the transaction has been completed and recorded.

4. The method of claim 3 further comprising the step of:
sending a signal to the sales associate to request additional id ntification by the user if the signature comparison does not meet predetermined criteria.

5. The method of claim 3 further comprising the step of:
sending a signal to the sales associate to confiscate the payment card if the payment card has been reported as being lost or stolen.

6. The method of claim 2 wherein said predetermined contact telecommunication method is email.

7. The method of claim 2 wherein said predetermined contact telecommunication method is mobile telephone.

8. The method of claim 2 wherein said predetermined contact telecommunication method cannot be changed at the point of sale.

9. The method of claim 2 wherein said predetermined contact telecommunication method can be changed at the point of sale.

10. The method of claim 2 further comprising the step of:
electronically providing the user with a copy of the transaction via said predetermined contact telecommunication method.

11. The method of claim of claim 2 wherein the signature block of the payment is adapted to record a predetermined contact telecommunication method that overrides any previously submitted contact telecommunication method.

12. The method of claim 2 further comprising the step of transmitting transaction information to an electronic journal via said predetermined contact telecommunication method such that the user can determine if unauthorized transactions are being recorded on said user's payment card.
